(19) United States
(12) Patent Application Publication
(10) Pub. No.: US 2009/0068509 A1
(43) Pub. Date: Mar. 12, 2009

(54) Process for Operating a Fuel Cell Arrangement and Fuel Cell Arrangement

(76) Inventors: Marc Bednarz, Ottobrunn (DE); Stefan Rolf, Grafing (DE); Alexander Gienapp, Munchen (DE)

Correspondence Address: Klaus P. Stoffel;Wolff & Samson, One Boland Drive, West Orange, NJ, 07052, US

(21) Appl. No.: 11/920,293

(22) PCT Filed: May 9, 2006
(86) PCT No.: PCT/EP2006/004295

§ 371 Date: Dec. 7, 2007

(30) Foreign Application Priority Data
May 12, 2005 (DE) 10 2005 021 981.0

(51) Int. Cl. H01M 8/04; H01M 8/06

(52) U.S. Cl. 429/17; 429/20

(57) ABSTRACT

The invention concerns a method for operating a fuel cell system with fuel cells (2) arranged in a stack (1). It also concerns the fuel cell system itself. In the method of the invention and the fuel cell system of the invention, a fuel gas is partially converted to hydrogen in first reforming units (4) that are in thermal contact with the fuel cells (2) in an endothermic reaction with absorption of heat from the fuel cells (2). This reformed fuel gas is supplied to the anodes of the fuel cells (2). In accordance with the invention, more hydrogen is produced in the first reforming units (4) than is needed in the fuel cell (2), and a portion of the hydrogen-containing reformed fuel gas is removed from the first reforming units (4) and supplied to a second reforming unit (3), where the hydrogen contained in the reformed fuel gas supplied to the second reforming unit (3) is subjected to an exothermic reverse reaction in the second reforming unit (3), and the heat liberated in this reaction is eliminated by cooling the second reforming unit (3).

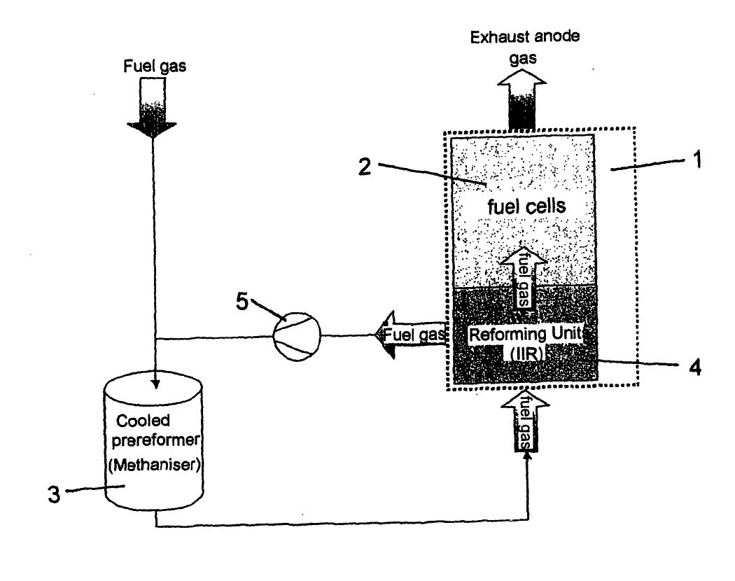

The invention concerns a method for operating a fuel cell system in accordance with the introductory clause of claim 1 and the fuel cell system itself in accordance with the introductory clause of claim 6.

The power density of a fuel cell system with fuel cells arranged in the form of a stack, e.g., especially a fuel cell system with molten carbonate fuel cells (MCFC), is limited by, among other things, the potential cooling capacity, i.e., the amount of heat that can be removed from the fuel cell stack during its operation. With increasing power density, the amount of heat produced in each fuel cell also increases, and if this heat can no longer be removed to a sufficient extent, a further increase in the power density is no longer possible.

It is well known that the fuel gas to be reacted in the fuel cell can be processed by internal reforming. In this regard, for example, the methane present in natural gas is reacted in the presence of water vapor to form hydrogen, carbon monoxide, and carbon dioxide in a catalytic steam reforming process:
CH₄+H₂O

[symbol]

### CO+3H₂,

CO+H₂O

[symbol]

### CO₂+H₂.

This can be done in the form of direct or indirect internal reforming. In contrast to direct internal reforming, in which the reaction occurs in the anode compartment of the fuel cell itself, indirect internal reforming takes place in a reforming unit that is in thermal contact with the anode but is separated from the anode. Indirect internal reforming is described in “Molten Carbonate Fuel Cell with Indirect Internal Reforming”, Journal of Power Sources, 52 (1994), pp. 41-47.

A process in which both of the reactions specified above take place, of which the first reaction, i.e., the methane steam reforming reaction, is strongly endothermic, while the second reaction, i.e., the shift reaction, is exothermic, is also described in the dissertation “Investigations of the Reaction Kinetics of Methane Steam Reforming and Shift Reaction in Anodes of Oxide Ceramic Fuel Cells” of the Department of Engineering of the University of Erlangen-Nuremberg, presented by Robert Reinfelder, candidate for the degree of Doctor of Engineering, Erlangen 2004.

In “Reforming of Hydrocarbons for the Generation of Hydrogen for Fuel Cells”, Dr. of Engineering Peter Hübner, Fraunhofer Institute for Solar Energy Systems ISE, describes three possibilities for generating hydrogen, namely, the aforementioned steam reforming of hydrocarbons to hydrogen and carbon monoxide in the presence of water vapor, as well as the process of partial oxidation, i.e., substoichiometric combustion, and the process of autothermal reforming as a combination of the first two processes.

Reforming reactions for processing fuels for fuel cells are also described in “Fuel Cells in Combined Heat and Power Coupling—an Energy Option for the Future?” Ludwig Jörissen et al., Forschungsverbund Sonnenenergie “Topics 98/99”.

EP 0 989 094 A2 also describes a process for the autothermal reforming of fuel that contains higher hydrocarbons by catalytic steam reforming. In this process, the fuel that contains the higher hydrocarbons is first passed through a reactor that contains the catalyst, in which the higher hydrocarbons are removed or reduced in the presence of water vapor. It is then fed into an autothermal reactor, in which a product gas rich in hydrogen and carbon monoxide is formed and then drawn off.

Finally, JP 63-25,783 describes internal reforming in a molten carbonate fuel cell system, where a pre-reformer designed as a heat exchanger is provided, in which a steam reforming reaction takes place with heat exchange between the fuel cell exhaust gas and a hydrocarbon with a carbon number of two or more, i.e., with the transfer of heat from the exhaust gas leaving the fuel cells to the feedstock fuel gas. In this process, hydrocarbons such as butane or other light hydrocarbons can be used as fuel gas. The volume of the reformed gas produced from these types of hydrocarbons is much greater than in the case of methane reforming.

The objective of the invention is to develop an improved method for operating a fuel cell system in which the fuel cells can be operated with a higher power density. A further objective of the invention is to develop a fuel cell system in which the fuel cells can be operated with a higher power density.

The objective with respect to the method is achieved by a method with the features of claim 1.

The objective with respect to the fuel cell system is achieved by a fuel cell system with the features of claim 6.

Advantageous embodiments and modifications of the method and the fuel cell system of the invention are specified in the respective dependent claims.

In accordance with the invention, a method is developed for operating a fuel cell system with fuel cells arranged in a stack. In this method, a fuel gas is partially converted to hydrogen in first reforming units that are in thermal contact with the fuel cells in an endothermic reaction with absorption of heat from the fuel cells and is then supplied to the anodes of the fuel cells. The invention provides that more hydrogen is produced in the first reforming units than is needed or can be reacted in the fuel cell and that a portion of the hydrogen-containing reformed fuel gas is removed from the first reforming units and supplied to a second reforming unit. The hydrogen contained in the reformed fuel gas supplied to the second reforming unit is subjected to an exothermic reverse reaction in the second reforming unit, and the heat liberated in this reaction is eliminated by cooling the second reforming unit.

The fuel gas removed from the first reforming units is preferably supplied to the second reforming unit together with fresh, externally supplied feedstock fuel gas.

The endothermic reaction that takes place in the first reforming units preferably comprises the reactions
CH₄+H₂O

[symbol]

### CO+3H₂ and

CO+H₂O

[symbol]

### CO₂+H₂.

The exothermic reverse reaction that takes place in the second reforming unit preferably comprises the reaction
4H₂+CO₂

[symbol]

### CH₄+2H₂O.

In accordance with a preferred embodiment of the invention, the reverse reaction in the second reforming unit is adjusted by adjusting the temperature by means of the intensity of the cooling.

In addition, the invention creates a fuel cell system with fuel cells arranged in a stack and with first reforming units that are in thermal contact with the fuel cells, where fuel gas is partially converted to hydrogen in the first reforming units in an endothermic reaction with absorption of heat from the fuel cells and is then supplied to the anodes of the fuel cells. The invention provides that more hydrogen is produced in the first reforming units than can be reacted in the fuel cell and that a second reforming unit, which can be cooled, is provided. A portion of the hydrogen-containing reformed fuel gas is removed from the first reforming units and supplied to a second reforming unit. The hydrogen contained in the reformed fuel gas supplied to the second reforming unit is subjected to an exothermic reverse reaction in the second reforming unit, and the heat liberated in this reaction is eliminated by cooling the second reforming unit.

The second reforming unit is preferably a pre-reformer for receiving the fuel gas removed from the first reforming units together with fresh, externally supplied feedstock fuel gas.

A conveying device is preferably provided for returning the fuel gas removed from the first reforming units to the second reforming unit.

The conveying device that is provided for returning the fuel gas removed from the first reforming units to the second reforming unit can be a pump or a side channel compressor.

In accordance with a preferred embodiment of the invention, the second reforming unit is provided for adjusting the reverse reaction by adjusting the temperature by means of the intensity of the cooling.

A specific embodiment of the invention is explained below with reference to the accompanying figure.

The figure shows a schematic block diagram of a specific embodiment of the invention.

The fuel cell system shown in the drawing contains fuel cells 2 arranged in a stack 1. Only one of these fuel cells is shown schematically in the drawing. It serves the purpose of generating electric current from an externally supplied fuel gas, as indicated in the drawing by an arrow, and from an oxidizing gas, the supply of which is not shown in the drawing. Internal first reforming units 4, which are in thermal contact with the fuel cells 2, are provided. Once again, only one of these first reforming units 4 is shown schematically in the drawing. In the internal reforming units 4, fuel gas is partially converted to hydrogen in an endothermic reaction with absorption of heat from the fuel cells 2 and is then supplied to the anodes of the fuel cells 2. The fuel gas is supplied to the internal reforming units 4 via a second reforming unit in the form of a pre-reformer 3, in which the externally supplied feedstock fuel gas is first methanized by means which are already well known.

The internal reforming units 4 are intended for producing more hydrogen than can be reacted in the fuel cell 2. The pre-reformer 3 can be cooled. A portion of the hydrogen-containing reformed fuel gas is removed from the internal reforming units 4 and returned to the pre-reformer 3. The hydrogen contained in the reformed fuel gas returned to the pre-reformer 3 is subjected to an exothermic reverse reaction in the pre-reformer 3, and the heat liberated in this reaction is eliminated by cooling the pre-reformer 3. In the embodiment illustrated here, the pre-reformer 3 is thus intended to receive the fuel gas removed from the internal reforming units 4 together with fresh, externally supplied feedstock fuel gas.

To return the fuel gas removed from the first reforming units 4 to the second reforming unit 3, a conveying device 5 is provided, which, for example, can be a pump or a side channel compressor.

The coolable pre-reformer 3 is provided for adjusting the intensity and the course of the reverse reaction, i.e., the composition of the gases reacted in it. This adjustment is effected by adjusting the temperature by means of the intensity of the cooling.

In the method of the invention, more hydrogen is produced in the internal reforming units 4 than can be reacted in the fuel cell 2, and a portion of the hydrogen-containing reformed fuel gas is removed from the internal reforming units 4 and returned to the pre-reformer 3. The hydrogen contained in the reformed fuel gas returned to the pre-reformer 3 is subjected to an exothermic reverse reaction in the pre-reformer 3, and the heat liberated in this reaction is eliminated by cooling the pre-reformer 3. Due to the endothermic process in the internal reforming units 4, heat is removed from the fuel cells 2, which are thus cooled, and this heat is then eliminated by the exothermic process in the pre-reformer 3 by cooling the pre-reformer 3. This results in effective cooling of the fuel cell stack 1, which in turn allows an increase in the power density of the energy transformation in the fuel cells 2.

The fuel gas removed from the internal reforming units 4 is supplied to the pre-reformer 3 together with fresh, externally supplied feedstock fuel gas.

The endothermic reaction that takes place in the internal reforming units 4 can comprise the reactions
CH₄+H₂O

[symbol]

### CO+3H₂ and

CO+H₂O

[symbol]

### CO₂+H₂.

The exothermic reverse reaction that takes place in the pre-reformer 3 can comprise the reaction
4H₂+CO₂

[symbol]

### CH₄+2H₂O.

The reverse reaction in the pre-reformer 3 is adjusted, i.e., the intensity and the course of the reverse reaction and the composition of the gases reacted in it are adjusted, by adjusting the temperature by means of the intensity of the cooling.

1-10. (canceled)

11. A method for operating a fuel cell system having fuel cells arranged in a stack, comprising the steps of:
partially converting a fuel gas to hydrogen in first reforming units that are in thermal contact with the fuel cells in an endothermic reaction with absorption of heat from the fuel cells;
supplying the fuel gas to anodes of the fuel cells, whereby more hydrogen is produced in the first reforming units than is needed in the fuel cells;
removing a portion of the hydrogen-containing reformed fuel gas from the first reforming units;
supplying the removed portion of reformed fuel gas to a second reforming unit, where the hydrogen contained in the reformed fuel gas supplied to the second reforming unit is subjected to an exothermic reverse reaction in the second reforming unit; and
eliminating heat liberated in the exothermic reserve reaction by cooling the second reforming unit.

12. The method in accordance with claim 11, including supplying the fuel gas removed from the first reforming units to the second reforming unit together with fresh, externally supplied feedstock fuel gas.

13. The method in accordance with claim 11, wherein the endothermic reaction that takes place in the first reforming units comprises the reactions
CH₄+H₂O [symbol]
CO+3H₂ and
CO+H₂O [symbol]
CO₂+H₂.

14. The method in accordance with claim 11, the exothermic reverse reaction that takes place in the second reforming unit comprises the reaction
4H₂+CO₂ [symbol]
CH₄+2H₂O.

15. The method in accordance with claim 11, including adjusting the reverse reaction in the second reforming unit by adjusting the temperature using the intensity of the cooling.

16. A fuel cell system, comprising:
fuel cells arranged in a stack;
first reforming units that are in thermal contact with the fuel cell, whereby fuel gas is partially converted to hydrogen in the first reforming units in an endothermic reaction with absorption of heat from the fuel cells and is then supplied to anodes of the fuel cells, the first reforming units being operatively configured to produce more hydrogen than is needed in the fuel cells; and
a coolable second reforming unit in communication with the first reforming units so that a portion of the hydrogen-containing reformed fuel gas is removed from the first reforming units and supplied to the second reforming unit, whereby the hydrogen contained in the reformed fuel gas supplied to the second reforming unit is subjected to an exothermic reverse reaction in the second reforming unit, and heat liberated in the reverse reaction is eliminated by cooling the second reforming unit.

17. The fuel cell system in accordance with claim 16, wherein the second reforming unit is a pre-reformer for receiving the fuel gas removed from the first reforming units together with fresh, externally supplied feedstock fuel gas.

18. The fuel cell system in accordance with claim 16, and further comprising a conveying device for returning the fuel gas removed from the first reforming units to the second reforming unit.

19. The fuel cell system in accordance with claim 18, wherein the conveying device is a pump.

20. The fuel cell system in accordance with claim 18, wherein the conveying device is a side channel compressor.

21. The fuel cell system in accordance with claim 16, wherein the second reforming unit is operative for adjusting the reverse reaction by adjusting temperature by cooling intensity.
